(19) United States
(12) Patent Application Publication
(10) Pub. No.: US 2020/0331417 A1
(43) Pub. Date: Oct. 22, 2020

(54) STEERING APPARATUS

(71) Applicant: HONDA MOTOR CO., LTD., Tokyo (JP)

(72) Inventors: Seiji Kobata, Wako-shi (JP); Yuya Obayashi, Wako-shi (JP)

(21) Appl. No.: 16/840,488

(22) Filed: Apr. 6, 2020

(30) Foreign Application Priority Data
Apr. 18, 2019 (JP) 2019-079525

(51) Int. Cl. B60R 21/203; B62D 1/04; B62D 3/02

(52) U.S. Cl. CPC B60R 21/203; B62D 3/02; B62D 1/04

(57) ABSTRACT

A steering apparatus includes a steering wheel, a support frame, a frame fixation part, a steering transmission part, and an airbag unit. The frame fixation part extends substantially in parallel with a rotation center axis line of the steering wheel and fixes the support frame to a vehicle body. The steering transmission part transmits a rotation of the steering wheel relative to the support frame to a steering mechanism of a wheel. The support frame and the frame fixation part are arranged at a position that does not overlap with the rotation center axis line of the steering wheel in a front view of the steering wheel. The airbag unit is attached to the frame fixation part.

### CROSS-REFERENCE TO RELATED APPLICATION

Priority is claimed on Japanese Patent Application No. 2019-079525, filed on Apr. 18, 2019, the contents of which are incorporated herein by reference.

### BACKGROUND

### Field of the Invention

The present invention relates to a steering apparatus for steering a vehicle.

### Background

In a steering apparatus of a vehicle, a steering wheel is attached to a steering shaft that protrudes from a frontward direction of a driver's seat toward an upper rear part of the vehicle. A lower end side of the steering shaft is connected to a steering mechanism of a front wheel below a front side of the driver's seat. The steering wheel includes a boss part that is connected to a front end part of the steering shaft, a rim part that is gripped by a driver, and a plurality of spoke parts that connect the boss part to the rim part. The boss part is arranged at a rotation center position (on a rotation center axis line) of the rim part having an annular shape. An airbag unit that also functions as a horn operation part is attached to a surface of the boss part facing the driver's seat side (for example, refer to Japanese Unexamined Patent Application, First Publication No. H5-139319).

### SUMMARY

However, in the steering apparatus of the related art, the boss part is arranged on the rotation center axis line of the steering wheel, and the boss part is connected to the steering shaft that also serves as a support part of the steering wheel. Therefore, a view from a middle area on an inner circumferential side of the steering wheel toward an instrument panel direction is blocked by the boss part, the airbag unit, and the like.

Further, in the case of the steering apparatus of the related art, the airbag unit is arranged on a front end part of the steering shaft to be overlapped with the boss part of the steering wheel, and therefore, the shape of the airbag unit is limited to a substantially flat shape having a narrow width in depth. Therefore, the degree of freedom of the shape of a mounted airbag unit is limited.

An aspect of the present invention provides a steering apparatus capable of providing a good view of an inner circumferential side of a steering wheel toward an instrument panel direction and enhancing the degree of freedom of a shape of an airbag unit.

A steering apparatus according to an aspect of the present invention includes: a steering wheel that has a substantially annular shape and that is operated and rotated by a driver; a support frame that rotatably supports the steering wheel; a frame fixation part that extends substantially in parallel with a rotation center axis line of the steering wheel and that fixes the support frame to a vehicle body; a steering transmission part that transmits a rotation of the steering wheel relative to the support frame to a steering mechanism of a wheel; and an airbag unit in which a bag body is inflated and expanded in a driver's seat direction upon input of an impact, wherein the support frame and the frame fixation part are arranged at a position that does not overlap with the rotation center axis line in a front view of the steering wheel, and the airbag unit is attached to the frame fixation part.

According to the above configuration, when the steering wheel is operated and rotated, the steering wheel is rotated relative to the support frame in a state of being supported by the support frame. When the steering wheel is rotated, the rotation of the steering wheel is transmitted to the steering mechanism of the wheel through the steering transmission part. Since the frame fixation part and the support frame that supports the steering wheel having a substantially annular shape are arranged at a position that does not overlap with the rotation center axis line of the steering wheel in front of the steering wheel, a space that does not block a view toward an instrument panel direction is ensured in a middle area on an inner circumferential side of the steering wheel. Further, the airbag unit is attached to the frame fixation part that extends substantially in parallel with the rotation center axis line at a position that is offset from the rotation center axis line of the steering wheel. Therefore, it is possible to enlarge the width in depth of the airbag unit, and it is possible to reduce the size of a shape in a front view of the airbag unit when the steering wheel is viewed from the front.

The airbag unit may be arranged at a position that does not overlap with the rotation center axis line in the front view of the steering wheel.

In this case, the airbag unit that is provided on the frame fixation part also does not widely occupy a middle area on the inner circumferential side of the steering wheel. As a result, the view in the instrument panel direction at the inner circumferential side of the steering wheel is widely ensured.

The airbag unit may include a break guidance part that starts to break upon inflation and expansion of the bag body, and at least part of the break guidance part may be provided on a surface that faces the rotation center axis line of the airbag unit.

In this case, when the bag body of the airbag unit is inflated and expanded, the bag body breaks the break guidance part and starts to be inflated and expanded toward a direction of the rotation center axis line on the inner circumferential side of the steering wheel first, and then the bag body is inflated and expanded toward the driver's seat direction. Accordingly, when the present configuration is employed, it is possible to prevent the bag body of the airbag unit from being rapidly expanded toward the driver's seat direction in an early stage of the start of the inflation and expansion.

The airbag unit may have an attachment shaft that extends in a direction substantially perpendicular to a direction directed to a driver's seat and may be attached to the frame fixation part by the attachment shaft.

In this case, since the attachment shaft that attaches the airbag unit to the frame fixation part extends in the direction substantially perpendicular to the direction directed to the driver's seat, it is possible to advantageously receive a reaction force from the bag body by the attachment shaft when the bag body of the airbag unit is inflated and expanded toward the driver's seat direction.

The airbag unit may be attached to the frame fixation part such that the airbag unit is displaceable substantially in a vertical direction or substantially in a horizontal direction and may constitute a horn operation part.

In this case, since the horn operation part is constituted of an airbag unit having a small shape in a front view, it is possible to improve the appearance from the outside. Further, when the operation direction of the horn (airbag unit) is substantially the vertical direction, an occupant can perform a push-down operation from above, and therefore, the operability of the horn is improved.

The airbag unit may be attached to the frame fixation part via an elastic member such that the airbag unit is displaceable, and a mass of the airbag unit and the elastic member may constitute a dynamic damper.

In this case, the airbag unit having a small shape in a front view can prevent vibration of the steering wheel.

According to the aspect of the present invention, the frame fixation part and the support frame that supports the steering wheel having a substantially annular shape are arranged at a position that does not overlap with the rotation center axis line of the steering wheel in a front view of the steering wheel. Therefore, when the steering apparatus according to the aspect of the present invention is employed, a space that does not block a view toward the instrument panel direction is ensured at the inner circumferential side of the steering wheel, and the view toward the instrument panel direction is improved.

Further, in the aspect of the present invention, the airbag unit is attached to the frame fixation part that extends substantially in parallel with the rotation center axis line at a position that is offset from the rotation center axis line of the steering wheel. Therefore, when the steering apparatus according to the aspect of the present invention is employed, it is possible to enlarge the width in depth of the airbag unit, and it is possible to enhance the degree of freedom of the shape of the airbag unit.

### BRIEF DESCRIPTION OF THE DRAWINGS

FIG. 1 is a front view of a steering apparatus according to a first embodiment when seen from a driver's seat side.

FIG. 2 is a perspective view of a main part of the steering apparatus according to the first embodiment.

FIG. 3 is a front view of the main part of the steering apparatus according to the first embodiment.

FIG. 4 is an exploded perspective view of the main part of the steering apparatus according to the first embodiment.

FIG. 5 is a view showing an operation of the main part of the steering apparatus according to the first embodiment.

FIG. 6 is a cross-sectional view along a VI-VI line of FIG. 3 of the steering apparatus according to the first embodiment.

FIG. 7 is a perspective view of part of the steering apparatus according to the first embodiment.

FIG. 8 is an exploded perspective view of part of the steering apparatus according to the first embodiment.

FIG. 9 is a perspective view of part of an airbag module according to the first embodiment.

FIG. 10 is a side view of the steering apparatus showing an operation state of the airbag unit according to the first embodiment.

FIG. 11 is a perspective view of a steering apparatus according to a second embodiment.

FIG. 12 is a perspective view of a main part of the steering apparatus according to the second embodiment.

FIG. 13 is a front view of the main part of the steering apparatus according to the second embodiment.

FIG. 14 is an exploded perspective view of the main part of the steering apparatus according to the second embodiment.

FIG. 15 is a cross-sectional view along a XV-XV line of FIG. 13 of the steering apparatus according to the second embodiment.

FIG. 16 is a view showing an operation of the main part of the steering apparatus according to the second embodiment.

FIG. 17 is a schematic configuration view of a steering apparatus according to a third embodiment.

### DESCRIPTION OF EMBODIMENTS

Hereinafter, embodiments of the present invention will be described with reference to the drawings. In the embodiments described below, common parts are denoted by the same reference numerals, and redundant descriptions are omitted.

### First Embodiment

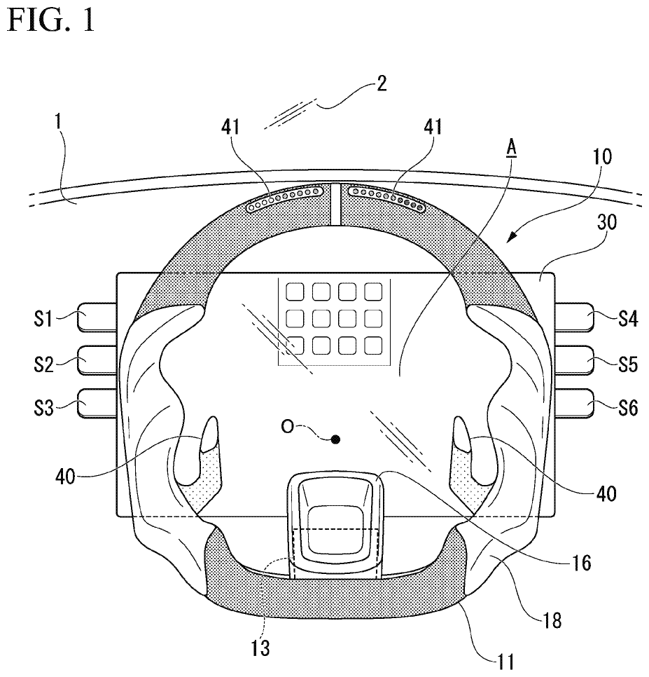

First, a first embodiment shown in FIG. 1 to FIG. 10 will be described.

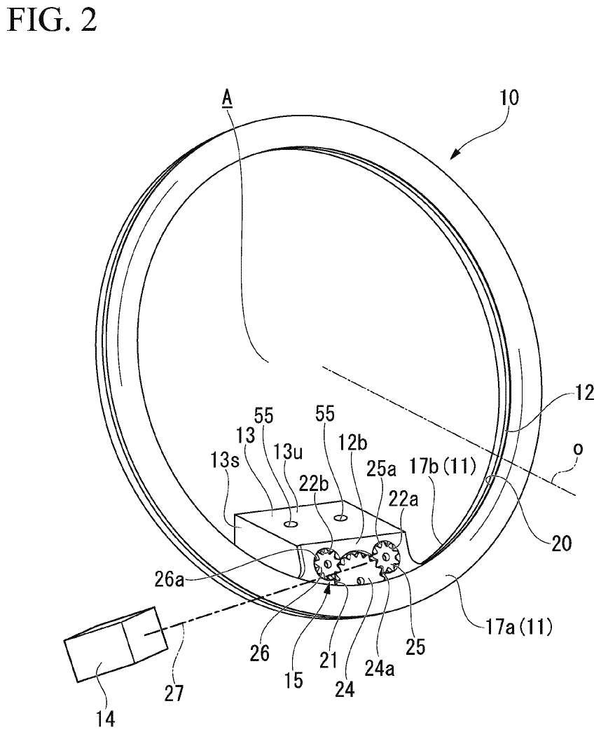

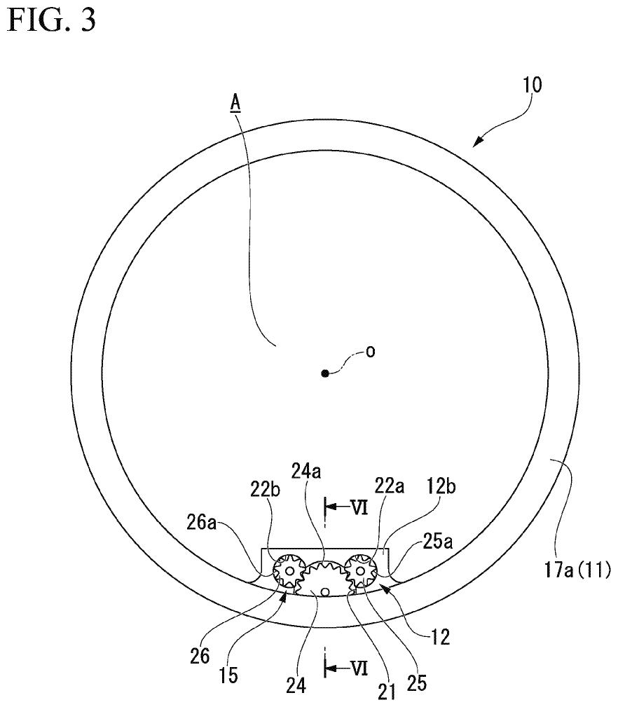

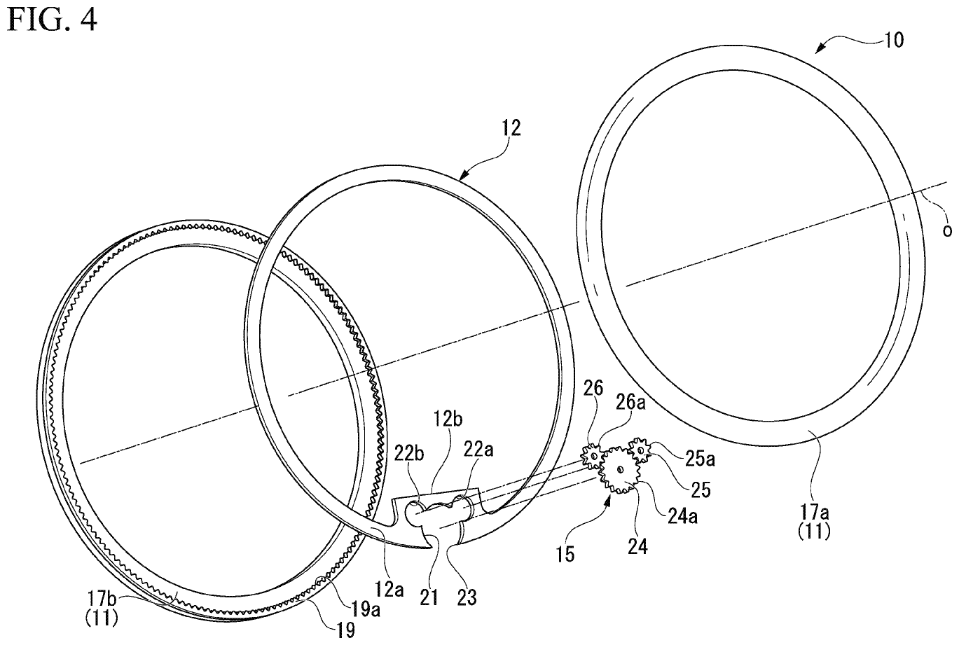

FIG. 1 is a view showing a front of a driver's seat of a vehicle that employs a steering apparatus 10 of the first embodiment. FIG. 2 is a perspective view of a main part of the steering apparatus 10. FIG. 3 is a front view of the main part of the steering apparatus 10. FIG. 4 is an exploded perspective view of the main part of the steering apparatus 10. In FIG. 1, reference numeral 1 indicates an instrument panel in front of the driver's seat, and reference numeral 2 indicates a front windshield in front of the driver's seat.

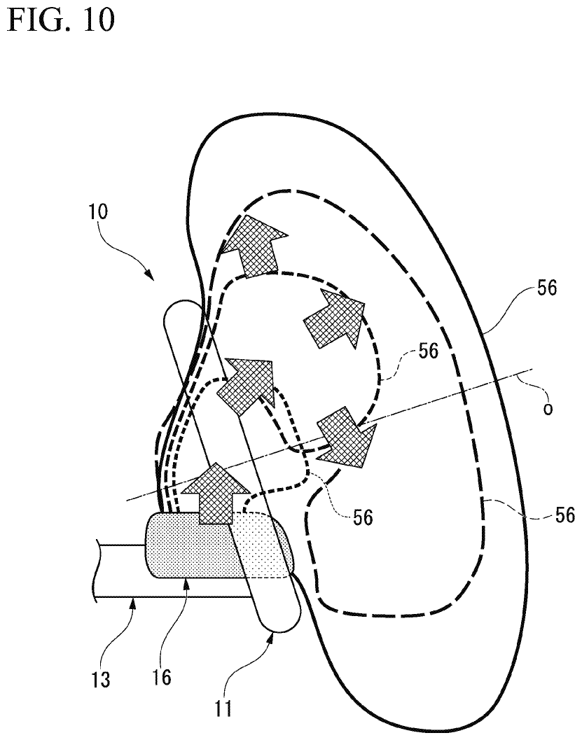

The steering apparatus 10 includes: a steering wheel 11 that has a substantially annular shape and that is operated and rotated by a driver; a support frame 12 that rotatably supports the steering wheel 11; a fixation stay 13 (refer to FIG. 2) that fixes the support frame 12 to a frame member of a vehicle body (not shown); and an operation transmission mechanism 15 (steering transmission part) that transmits a rotation of the steering wheel 11 to a steering mechanism 14; and an airbag unit 16 that inflates and expands a bag body 56 (refer to FIG. 10) upon input of an impact.

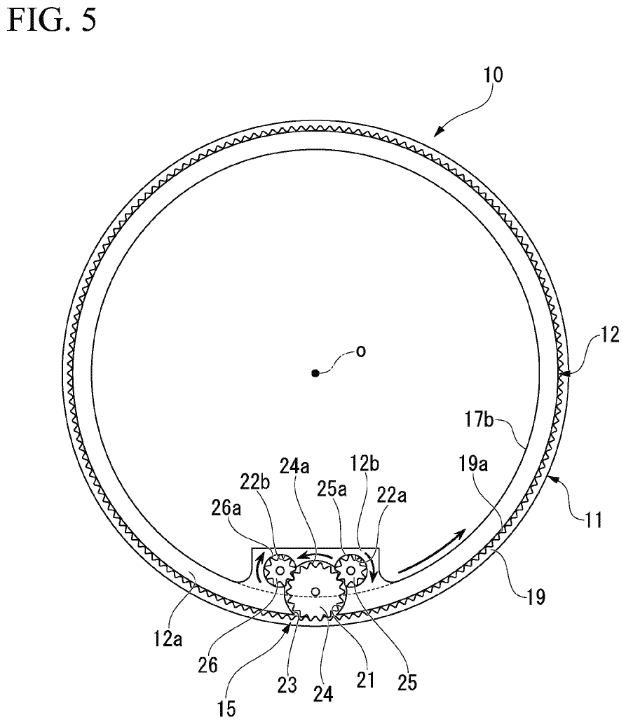

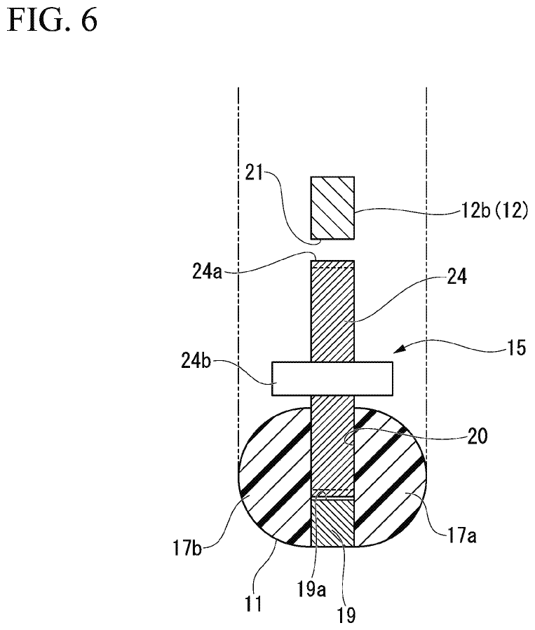

FIG. 5 is a view showing an operation of the main part of the steering apparatus 10. In FIG. 5, part of components (a wheel half body 17a which will be described later) is removed from the front view of the main part of FIG. 3. FIG. 6 is a cross-sectional view along a VI-VI line of FIG. 3. The scale of the cross-section of FIG. 3 is appropriately adjusted.

As shown in FIG. 2 to FIG. 6, the steering wheel 11 is obtained by joining two wheel half bodies 17a, 17b having a substantially annular shape together, and a circumference of the two wheel half bodies 17a, 17b joined together is covered by a cover material 18 (refer to FIG. 1). A ring gear 19 having an inner circumferential surface on which an internal tooth 19a is formed is sandwiched and fixed between the two wheel half bodies 17a, 17b.

An outer diameter of the ring gear 19 is formed to be substantially the same as a maximum outer diameter of the two wheel half bodies 17a, 17b. An inner diameter of the ring gear 19 is set to be larger than a minimum inner diameter of the two wheel half bodies 17a, 17b. An opening part 20 that opens radially inward is formed in an annular shape between the ring gear 19 and the two wheel half bodies 17a, 17b.

A pair of paddle levers 40 by which the driver can perform an operation of changing the speed of the vehicle while keeping a state of gripping the steering wheel 11 is attached to the steering wheel 11 (not shown in the drawings other than FIG. 1). An instrument 41 such as a tachometer is attached to a surface of the steering wheel 11 facing the driver's seat side. The instrument 41 is arranged in a region which is positioned at an upper side when the steering wheel 11 is at a neutral position.

The support frame 12 is formed of a plate material (metal plate) having a substantially annular shape. The support frame 12 includes a ring part 12a having a substantially annular shape and a protrusion piece 12b (protrusion part) having a substantially rectangular shape and protruding radially inward from a portion (lower region) of an inner circumferential edge section of the ring part 12a. A first gear accommodation hole 21 having a large diameter is formed in a region spanning the ring part 12a and the protrusion piece 12b. A second gear accommodation hole 22a having a small diameter and a third gear accommodation hole 22b having a small diameter are formed at two positions adjacent to the first gear accommodation hole 21 of the protrusion piece 12b. The second gear accommodation hole 22a and the third gear accommodation hole 22b communicate with the first gear accommodation hole 21. A cutout part 23 through which part of the first gear accommodation hole 21 opens to an outer circumferential side of the ring part 12a is provided in an area of an outer circumferential surface of the ring part 12a in which the protrusion piece 12b is provided. The cutout part 23 opens, by a predetermined width, part of the first gear accommodation hole 21 along a circumferential direction of the ring part 12a.

A first gear 24 having a large diameter is rotatably accommodated in the first gear accommodation hole 21. The first gear 24 includes an outer tooth 24a on an outer circumferential surface of the first gear 24. The outer tooth 24a of the first gear 24 is exposed to an outer circumferential side of the ring part 12a through the cutout part 23 of the ring part 12a. As shown in FIG. 6, the first gear 24 has a rotation shaft 24b, and the rotation shaft 24b is rotatably supported by the protrusion piece 12b via a shaft support part (not shown).

The ring part 12a of the support frame 12 is slidably accommodated in the opening part 20 on the inner circumferential side of the steering wheel 11. The ring part 12a rotatably supports the steering wheel 11 around a rotation center axis line o which is an axis center of the ring part 12a. The steering wheel 11 is supported coaxially with the ring part 12a. The outer tooth 24a of the first gear 24 exposed outside from the cutout part 23 of the ring part 12a is engaged with the inner tooth 19a of the ring gear 19 within the opening part 20 of the steering wheel 11. Therefore, when the steering wheel 11 is operated and rotated by the driver, the rotation of the steering wheel 11 is transmitted to the first gear 24 via the ring gear 19.

A second gear 25 having a small diameter is rotatably accommodated in the second gear accommodation hole 22a. A third gear 26 having a small diameter is rotatably accommodated in the third gear accommodation hole 22b. The second gear 25 has an outer tooth 25a, and the outer tooth 25a is engaged with the outer tooth 24a of the first gear 24. The third gear 26 has an outer tooth 26a, and the outer tooth 26a is engaged with the outer tooth 24a of the first gear 24. In the present embodiment, the output shaft 27 is integrally rotatably connected to the second gear 25.

The output shaft 27 penetrates through the instrument panel 1 and is connected to the steering mechanism 14 provided on a front lower part of the vehicle such that power is transmittable to the steering mechanism 14. Accordingly, a rotation operation force applied to the steering wheel 11 is transmitted from the ring gear 19 to the steering mechanism 14 via the first gear 24, the second gear 25, and the output shaft 27. The steering mechanism 14 steers a front wheel of the vehicle in response to a rotation force and a rotation direction of the steering wheel 11.

The third gear 26 is a gear for balancing and can be omitted. In the present embodiment, the first gear 24, the second gear 25, and the output shaft 27 constitute the mechanical operation transmission mechanism 15 (steering transmission part). The first gear 24 and the second gear 25 constitute a power transmission gear that transmits the rotation of the ring gear 19 to the steering mechanism 14.

As shown in FIG. 2, the fixation stay 13 is formed in a substantially U shape in a cross-section that includes a flat upper wall 13u and a side wall 13s extending downward from right and left end parts of the upper wall 13u, and the cross-section extends substantially parallel to the rotation center axis line o of the steering wheel 11. The cross-sectional shape of the fixation stay 13 is not limited to the substantially U shape. One end part of an extension direction of the fixation stay 13 is fixed to the frame member of the vehicle body (not shown). Another end part of the extension direction of the fixation stay 13 is integrally joined to the protrusion piece 12b of the support frame 12. In the present embodiment, the fixation stay 13 constitutes a frame fixation part that fixes the support frame 12 to the vehicle body.

In the present embodiment, the fixation stay 13 (frame fixation part) and the support frame 12 are constituted of separate components; however, the fixation stay 13 (frame fixation part) and the support frame 12 can be constituted of an integral component.

The fixation stay 13 and the protrusion piece 12b of the support frame 12 joined to the fixation stay 13 are arranged at a position that is offset downward by a predetermined amount from the rotation center axis line o of the steering wheel 11. The ring part 12a of the support frame 12 is arranged on an inner side of the opening part 20 on an inner circumferential side of the steering wheel 11. Accordingly, the fixation stay 13 and the support frame 12 (the protrusion piece 12b and the ring part 12a) are arranged at a position that does not overlap with the rotation center axis line o of the steering wheel 11 in a front view of the steering wheel 11.

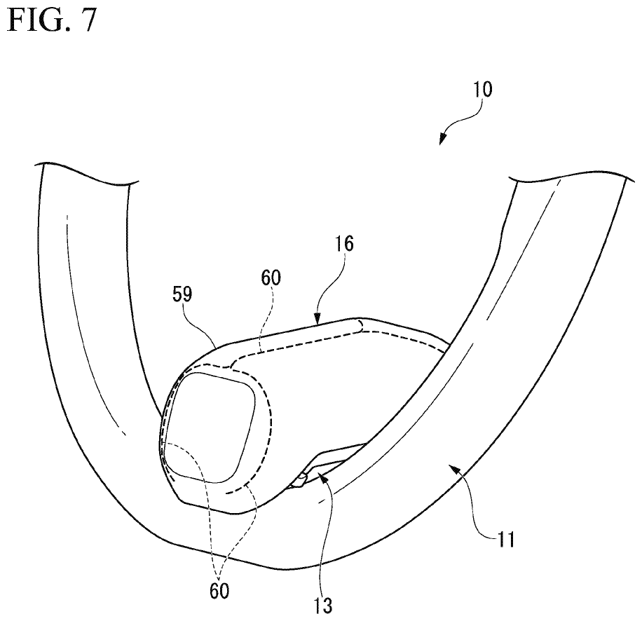

FIG. 7 is a perspective view of an attachment part of the airbag unit 16 of the steering apparatus 10.

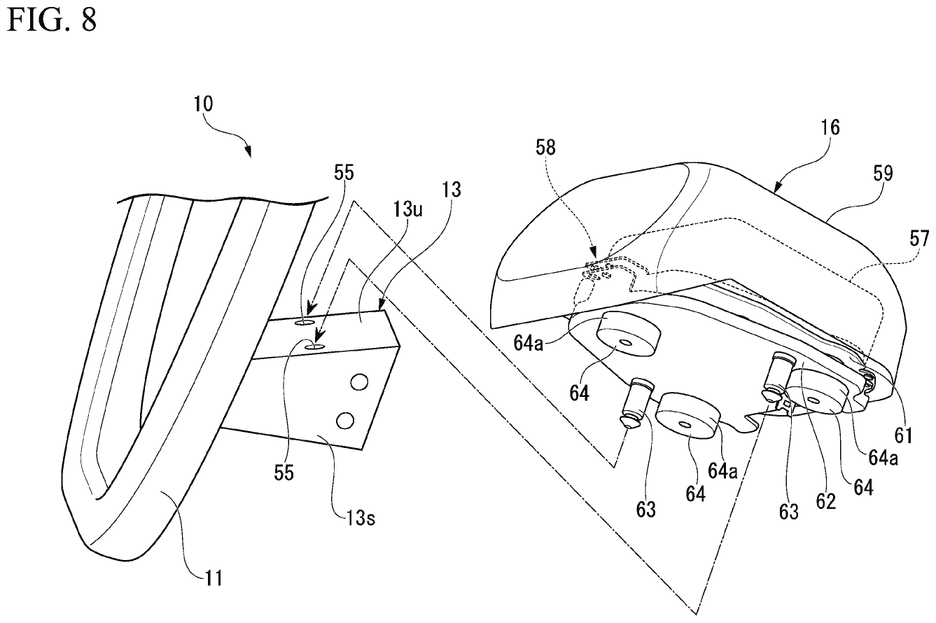

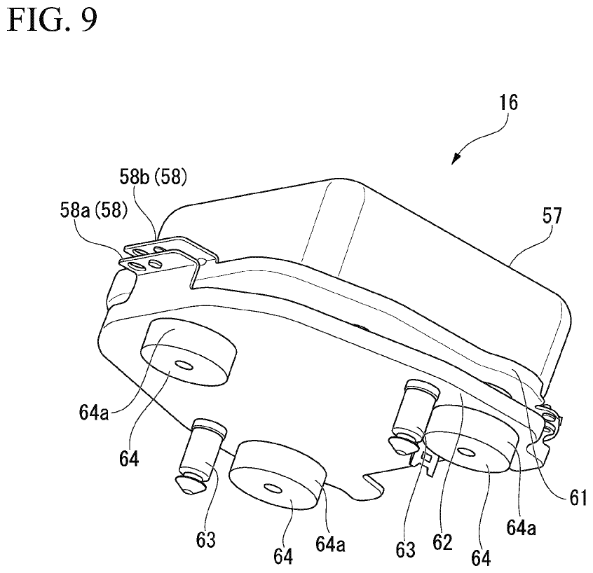

FIG. 8 is an exploded perspective view showing a state in which the airbag unit 16 is removed from the steering apparatus 10, and FIG. 9 is a perspective view of the airbag unit 16 in which part of components (a steering pad 59 described later) is removed. FIG. 10 is a side view of the steering apparatus 10 showing an operational state of the airbag unit 16.

The airbag unit 16 is attached to the upper wall 13u of the fixation stay 13. As shown in FIG. 2 and FIG. 8, a pair of attachment holes 55 to which the airbag unit 16 is attached are formed on the upper wall 13u of the fixation stay 13.

As shown in FIG. 8 and FIG. 9, the airbag unit 16 includes a horn switch 58 for warning and a unit main body 57 having a folded bag body 56 (refer to FIG. 10), an inflator (not shown), and the like. A circumferential area including upper surfaces of these components and a front surface on the driver's seat side of the airbag unit 16 is covered by a steering pad 59 which is a cover member made of a resin. The unit main body 57 is formed in a substantially rectangular shape in a top view that is elongated in a direction along the rotation center axis line o (substantially a vehicle front-to-rear direction). The steering pad 59 that covers the unit main body 57 is similarly formed in a substantially rectangular shape in a top view. A break guidance part 60 (tear line) is continuously formed on a top surface facing the rotation center axis line o direction and a front surface facing the driver's seat side of the steering pad 59. The break guidance part 60 is formed to be thin relative to other parts around the break guidance part 60 and breaks the steering pad 59 along the break guidance part 60 when the bag body 56 is inflated and expanded.

The airbag unit 16 includes: a retainer 61 made of a metal and having an upper surface side to which the unit main body 57 described above is attached; the above-described steering pad 59 attached to the retainer 61 in a state of covering an outside of the unit main body 57; and a base plate 62 made of a metal, arranged below the retainer 61, and holding the retainer 61 such that the retainer 61 can be displaced back and forth in an up-and-down direction.

A spring (not shown) for biasing the retainer 61 upward is provided between the retainer 61 and the base plate 62. An upward displacement of the retainer 61 that holds the unit main body 57 is regulated relative to the base plate 62 by a displacement regulation part (not shown). A fixed contact point 58a is provided on the base plate 62. A movable contact point 58b is provided on the retainer 61. The fixed contact point 58a and the movable contact point 58b constitute the horn switch 58. The movable contact point 58b is in a non-contact state with the fixed contact point 58a in an initial state in which the retainer 61 is separated from the base plate 62. The movable contact point 58b comes into contact with the fixed contact point 58a when the steering pad 59 is pushed downward, and the retainer 61 approaches the base plate 62. As a result, a horn circuit (not shown) is turned on, and a horn emits an alarm sound.

A pair of support pins 63 (attachment shaft) are provided to protrude and be spaced apart from each other on a lower surface of the base plate 62. Both support pins 63 extend in a downward direction (substantially vertically downward direction) that is substantially perpendicular to a direction facing the driver's seat. Each support pin 63 is inserted into the attachment hole 55 of the upper wall 13u of the fixation stay 13 and is locked to the upper wall 13u by a snap-fit structure (not shown). Each support pin 63 is slidably inserted into the attachment hole 55. Thereby, the base plate 62 is displaceable slightly upward and downward relative to the upper wall 13u.

Three damper units 64 are attached to a lower surface of the base plate 62. Each damper unit 64 has an elastically deformable rubber-like elastic member 64a. A lower surface of the damper unit 64 is in contact with an upper surface of the upper wall 13u in a state where the base plate 62 is attached to the upper wall 13u of the fixation stay 13 via the support pin 63. Accordingly, the airbag unit 16 is supported by the upper wall 13u of the fixation stay 13 via the rubber-like elastic member 64a of the three damper unit 64. The rubber-like elastic member 64a constitutes a dynamic damper using the mass of the airbag unit 16 as a damper mass. This dynamic damper prevents vibration of the steering apparatus 10 by resonating with vehicle vibration in a predetermined frequency range.

As described above, the airbag unit 16 attached to the fixation stay 13 is positioned in an area (an area that is offset downward by a predetermined amount relative to the rotation center axis line o) that does not overlap with the rotation center axis line o of the steering wheel 11 in the front view of the steering wheel 11.

In the airbag unit 16, when an input of an impact is detected by a sensor (not shown), the inflator in the unit main body 57 is operated to inflate and expand the bag body 56. At this time, the bag body 56 breaks the break guidance part 60 on an upper surface of the steering pad 59, and initially begins to expand toward a direction (upward direction) of a rotation center axis line p on the inner circumferential side of the steering wheel 11 as shown in FIG. 10. The bag body 56 then changes the expansion direction to the driver's seat side and eventually expands so as to cover a large range on a rear side of the steering wheel 11 and on a front side of the driver's seat.

In the steering apparatus 10 of the present embodiment, the fixation stay 13, the airbag unit 16, the support frame 12, and the like are not arranged in a middle area that includes the rotation center axis line o on an inner circumferential side of the steering wheel 11, and a large space that does not block a view of the driver in the instrument panel 1 direction is ensured. The space is defined as an access area A through which the instrument panel 1 is visible and operable.

In the case of the present embodiment, as shown in FIG. 1, a display panel 30 such as a liquid crystal panel which can be operated by a touch operation is arranged at a front position of the driver's seat of the instrument panel 1. The display panel 30 is adapted to appropriately switch among a display of a current driving situation such as a vehicle speed, a display of a navigation screen, another information display, and the like by operating a selector switch (not shown). The screen of the display panel 30 can be viewed through the large access area A on the inner side of the steering wheel 11. The touch operation or the like on the display panel 30 can also be performed through the large access area A on the inner circumferential side of the steering wheel 11.

Further, in the steering apparatus 10 of the present embodiment, since a steering shaft, a steering column, or the like is not present on the rotation center axis line o of the steering wheel 11, various switches S1 to S6 such as a winker switch and a wiper switch which are generally provided on the steering column or the like are provided at a front position of the instrument panel 1 as shown in FIG. 1.

In the steering apparatus 10 having the configuration described above, when the steering wheel 11 is operated and rotated by the driver, the steering wheel 11 is rotated relative to the support frame 12 in a state of being held by the support frame 12. When the steering wheel 11 is rotated in this way, the rotation of the steering wheel 11 is transmitted to the steering mechanism 14 through the ring gear 19, the first gear 24, the second gear 25, and the output shaft 27 as the steering transmission part in this order.

At this time, the fixation stay 13 (frame fixation part) and the support frame 12 that supports the steering wheel 11 having a substantially annular shape are arranged at a position that does not overlap with the rotation center axis line o of the steering wheel 11 in a front view of the steering wheel 11. According to this configuration, a space (access area A) that does not block a view in the instrument panel 1 direction is ensured in a middle area on an inner circumferential side of the steering wheel 11. Accordingly, when the steering apparatus 10 of the present embodiment is employed, the view in the instrument panel direction is improved.

Further, in the steering apparatus 10 of the present embodiment, the airbag unit 16 is attached to the upper wall 13u of the fixation stay 13 extending substantially parallel to the rotation center axis line o at a position that is offset downward from the rotation center axis line o of the steering wheel 11. Therefore, it is possible to enlarge the width in depth in the vehicle front-to-rear direction of the airbag unit 16, and it is possible to reduce the size of a shape in a front view of the airbag unit 16 when the steering wheel 11 is viewed from the front. Accordingly, when the steering apparatus 10 of the present embodiment is employed, it is possible to enhance the degree of freedom of the shape of the airbag unit 16.

Further, in the steering apparatus 10 of the present embodiment, the airbag unit 16 attached to the fixation stay 13 is also arranged at a position that is offset downward from the rotation center axis line o of the steering wheel 11. Therefore, the airbag unit 16 also does not widely occupy a middle area on the inner circumferential side of the steering wheel 11. As a result, the view in the instrument panel direction at the inner circumferential side of the steering wheel 11 is widely ensured. Further, when the steering apparatus 10 of the present embodiment is employed, since a large access area A on the inner circumferential side of the steering wheel 11 is ensured, it is possible to easily perform visual recognition with respect to the instrument panel 1, a touch operation with respect to the display panel 30, and the like through the large access area A.

Further, in the steering apparatus 10 of the present embodiment, since the break guidance part 60 of the airbag unit 16 is provided on an upper surface that faces the rotation center axis line o, it is possible to prevent the bag body 56 of the airbag unit 16 from being rapidly expanded toward the driver's seat direction in an early stage of the start of the inflation and expansion.

Further, in the steering apparatus 10 of the present embodiment, the airbag unit 16 is attached to the fixation stay 13 (frame fixation part) by the support pin 63 (attachment shaft) that extends in a direction (substantially vertically downward direction) substantially perpendicular to a direction directed to the driver's seat. Therefore, it is possible to advantageously receive a reaction force from the bag body 56 by the support pin 63 when the bag body 56 of the airbag unit 16 is inflated and expanded toward the driver's seat direction. That is, the reaction force when the bag body 56 is inflated and expanded acts on the support pin 63 from a perpendicular direction to the shaft and is therefore rigidly received by the fixation stay 13 via the support pin 63.

Further, in the steering apparatus 10 of the present embodiment, the airbag unit 16 that is arranged to be offset from the rotation center axis line o is attached to the fixation stay 13 such that the airbag unit 16 is displaceable substantially in the vertical direction and constitutes a horn operation part. In the case of the present embodiment, since the horn operation part is constituted of the airbag unit 16 having a small shape in a front view, it is possible to improve the appearance from the outside. Specifically, in the case of the present embodiment, since the operation direction of the horn (airbag unit 16) is substantially the vertical direction, the occupant can easily perform a push-down operation from above by his/her hand, and the operability of the horn is improved.

Further, in the steering apparatus 10 of the present embodiment, the airbag unit 16 is attached to the fixation stay 13 via the rubber-like elastic member 64a such that the airbag unit 16 is displaceable, and the rubber-like elastic member 64a together with the mass of the airbag unit 16 constitutes a dynamic damper. Accordingly, when the steering apparatus 10 of the present embodiment is employed, the airbag unit 16 having a small shape in a front view can prevent vibration of the steering wheel 11.

### Second Embodiment

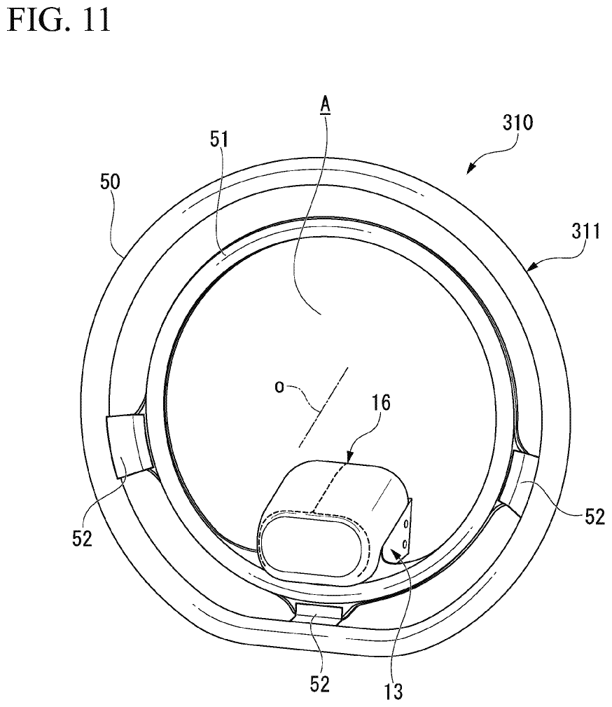

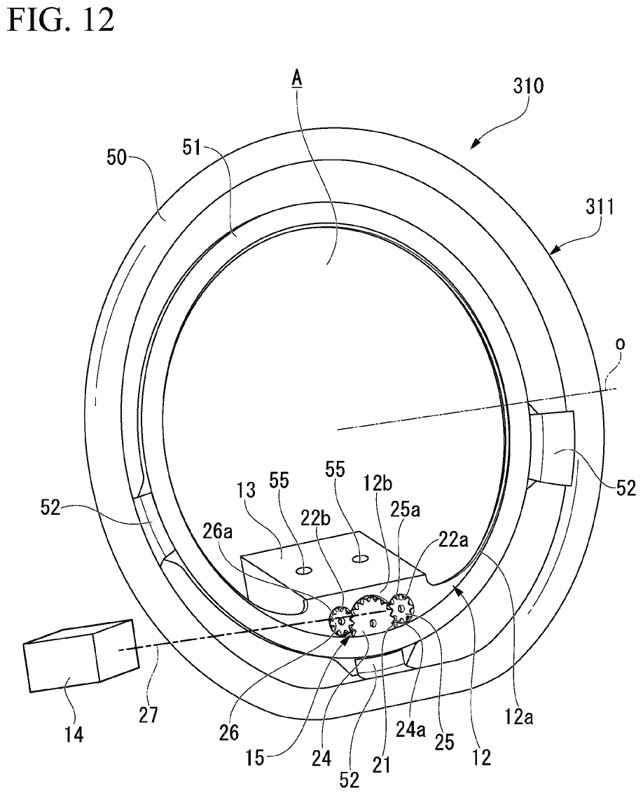

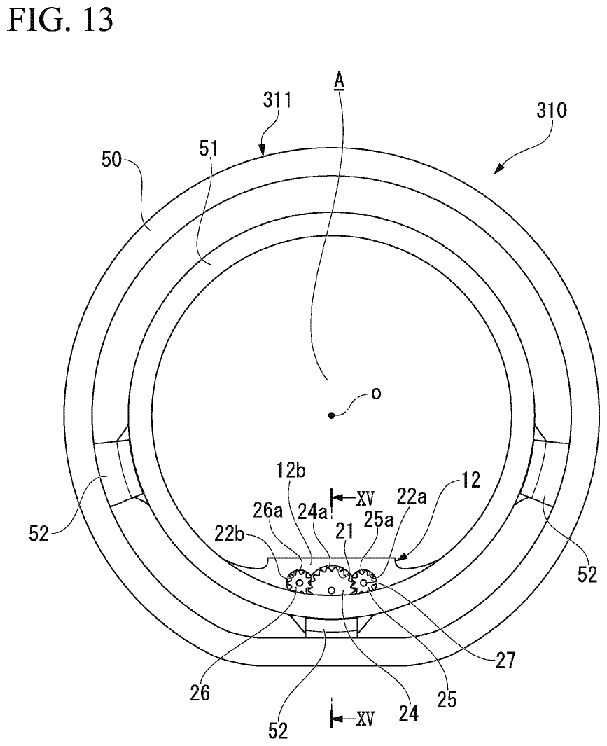

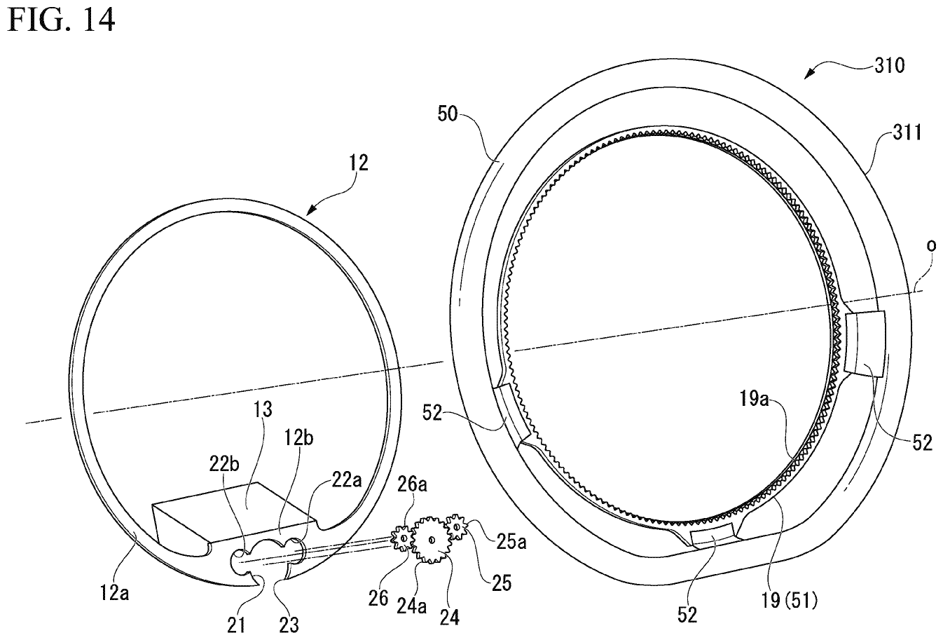

FIG. 11 is a perspective view of a steering apparatus 310 according to a second embodiment. FIG. 12 is a perspective view of a main part of the steering apparatus 310. FIG. 13 is a front view of the main part of the steering apparatus 310. FIG. 14 is an exploded perspective view of the main part of the steering apparatus 310.

In the steering apparatus 310 of the present embodiment, a basic configuration is substantially similar to that of the first embodiment, but a structure of a steering wheel 311 is different from that of the first embodiment. The steering wheel 311 of the present embodiment includes a main wheel 50 having a large diameter and gripped by the driver and a supplement wheel 51 that has a small diameter, is arranged on an inner circumferential side of the main wheel 50, and is rotated integrally with the main wheel 50. The main wheel 50 and the supplement wheel 51 are formed in a substantially annular shape and are connected together via a plurality of connection pieces 52. The supplement wheel 51 is arranged coaxially with the main wheel 50 at a position that is offset frontward with respect to the main wheel 50. Although not shown in the drawings, a hazard switch, an operation switch of a navigation device, and the like can be provided on the supplement wheel 51 that is not directly gripped by the driver.

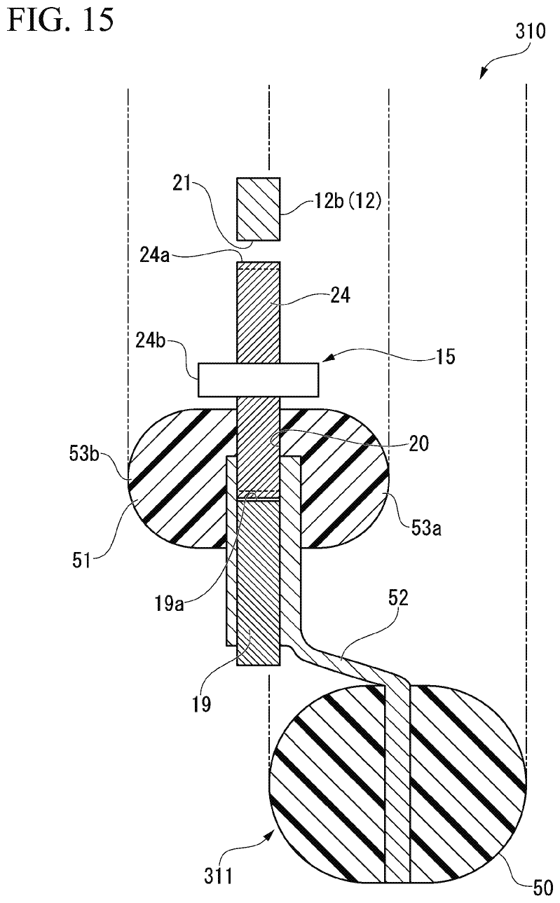

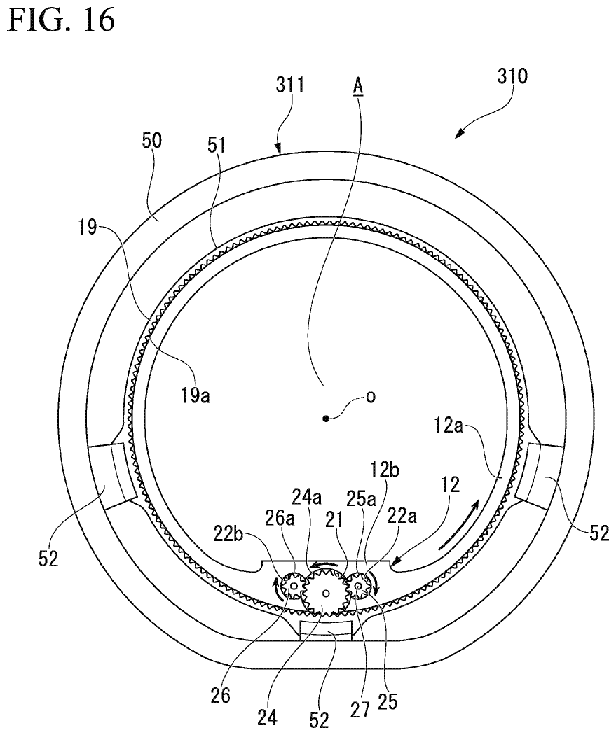

FIG. 15 is a cross-sectional view along a XV-XV line of FIG. 13. The scale of the cross-section of FIG. 15 is appropriately adjusted. FIG. 16 is a view showing an operation of the main part of the steering apparatus 310. In FIG. 16, part of components (a supplement wheel half body 53a which will be described later) is removed from the front view of the main part of FIG. 13.

The supplement wheel 51 is obtained by joining two supplement wheel half bodies 53a, 53b having a substantially annular shape together. A ring gear 19 is sandwiched between the two supplement wheel half bodies 53a, 53b. The ring gear 19 is fixed to an outer circumferential edge part of the two supplement wheel half bodies 53a, 53b and forms an annular opening part 20 between the ring gear 19 and an inner circumferential edge part of the supplement wheel half bodies 53a, 53b. A ring part 12a of the support frame 12 is accommodated inside the opening part 20.

The ring part 12a slidably holds the supplement wheel 51. The supplement wheel 51 and the main wheel 50 are supported by the support frame 12 rotatably around a rotation center axis line o.

The support frame 12 has a structure similar to that of the first embodiment. The support frame 12 includes the ring part 12a described above and a protrusion piece 12b (protrusion part). The first gear 24, the second gear 25, and the third gear 26 are held in an area spanning the protrusion piece 12b (protrusion part) and the ring part 12a. The first gear 24 is engaged with the internal tooth 19a of the ring gear 19, and the output shaft 27 is connected to the second gear 25. When the main wheel 50 is operated and rotated by the driver, the ring gear 19 of the supplement wheel 51 is rotated together with the main wheel 50 as indicated by an arrow in FIG. 16. When the ring gear 19 is rotated in this way, the rotation is transmitted to the output shaft 27 via the first gear 24 and the second gear 25.

In the case of the present embodiment, the support frame 12 and the fixation stay 13 (frame fixation part) are arranged at a position that does not overlap with the rotation center axis line o of the steering wheel 311 in the front view of the steering wheel 311. The airbag unit 16 (refer to FIG. 11) similar to that of the first embodiment is attached to the upper wall 13u of the fixation stay 13. The airbag unit 16 is arranged to be offset downward relative to the rotation center axis line o.

Accordingly, in the case of the present embodiment, a large access area A that includes a part through which the rotation center axis line o passes is ensured at an inner circumferential side of the steering wheel 311 (supplement wheel 51).

Since the basic configuration of the steering apparatus 310 of the present embodiment is substantially similar to that of the first embodiment, it is possible to obtain an advantage similar to that of the first embodiment.

However, in the steering apparatus 310 of the present embodiment, the supplement wheel 51 that is not gripped by the driver at an ordinary time is rotatably supported by the support frame 12. Therefore, even in a case where the steering wheel 11 is operated and rotated to a position across the protrusion piece 12b of the support frame 12 while keeping a state where the driver grips the main wheel 50, a finger of the driver who grips the main wheel 50 does not come into contact with the protrusion piece 12b. Accordingly, in the steering apparatus 310 of the present embodiment, there is an advantage that the rotation operation of the driver who grips the steering wheel 11 becomes easy.

### Third Embodiment

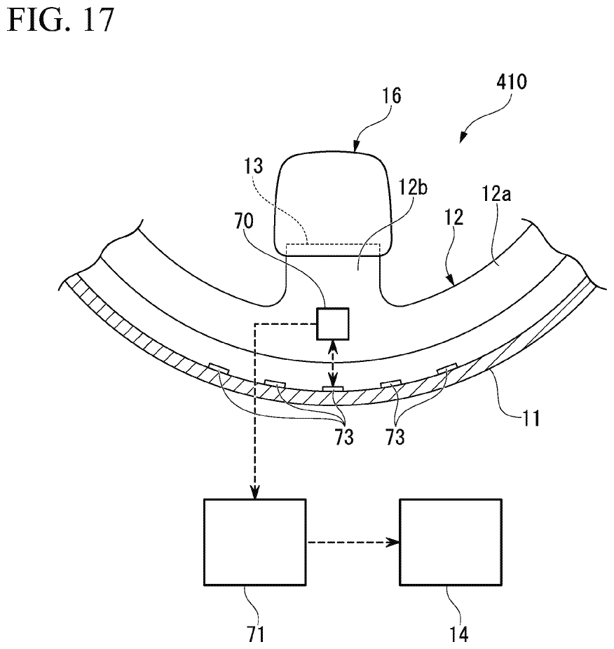

FIG. 17 is a schematic configuration view of a steering apparatus 410 according to a third embodiment.

In the embodiments described above, the steering transmission part that transmits the rotation of the steering wheel to the steering mechanism of the wheel is constituted of the mechanical operation transmission mechanism. However, in the steering apparatus 410 of the present embodiment, the steering transmission part includes a steering detection section 70 that detects rotation information of the steering wheel 11 and a steering actuator 71 such as a motor that operates the steering mechanism 14 on the basis of the information detected by the steering detection part 70.

In the case of the present embodiment, the fixation stay 13 (frame fixation part) and the support frame 12 that rotatably supports the steering wheel 11 are arranged at a position that does not overlap with a rotation center axis line of the steering wheel 11 in a front view of the steering wheel 11. The fixation stay 13 extends substantially parallel to the rotation center axis line. The airbag unit 16 is attached to an upper surface of the fixation stay 13. The airbag unit 16 is arranged at a position that is offset downward from the rotation center axis line.

The steering detection section 70 can be constituted of, for example, an information reading device such as a sensor or a camera provided on the support frame 12 and a detection target provided on an inner circumferential surface of the steering wheel 11. The information read by the steering detection section 70 is input to a control apparatus (not shown), and the control apparatus controls the steering actuator 71 in accordance with steering information. The configuration of the steering detection section 70 is not limited to the above-described one, and it is possible to employ various types of devices such as a capacitance-type device, a device using a QR code (registered trademark), or a device using a bar code as long as the device can detect a rotation direction, a rotation position, an operation speed, and the like of the steering wheel 11 as an electric signal.

The steering apparatus 410 of the present embodiment has a configuration in which the steering information of the steering wheel 11 is detected by the steering detection section 70, and the steering actuator 71 is controlled on the basis of the detected information. Therefore, it is possible to enhance the degree of freedom of the arrangement of configuration components compared to a case where an operation force of the steering wheel 11 is transmitted to the steering mechanism 14 via the mechanical operation transmission mechanism. Accordingly, when the configuration of the present embodiment is employed, there is an advantage from the viewpoint of a component layout of the vehicle.

The present invention is not limited to the embodiments described above, and various design changes can be made without departing from the scope of the invention. For example, in the embodiments described above, the support pin 63 (attachment shaft) is provided to protrude on the lower surface side of the airbag unit 16, and the support pin 63 is attached to the upper wall 13u of the fixation stay 13 (frame fixation part) by a snap-fit structure; however, the support pin 63 can be attached to the fixation stay 13 by a nut or the like.

Further, in the embodiments described above, a structure is employed in which the airbag unit 16 is displaceable substantially in the vertical direction, and the steering pad 59 is pushed downward at the time of a horn operation; however, a configuration may be employed in which the airbag unit 16 is displaceable substantially in a horizontal direction, and the steering pad 59 is pushed in a vehicle frontward direction at the time of a horn operation.

What is claimed is:

1. A steering apparatus comprising:
a steering wheel that has a substantially annular shape and that is operated and rotated by a driver;
a support frame that rotatably supports the steering wheel;
a frame fixation part that extends substantially in parallel with a rotation center axis line of the steering wheel and that fixes the support frame to a vehicle body;
a steering transmission part that transmits a rotation of the steering wheel relative to the support frame to a steering mechanism of a wheel; and
an airbag unit in which a bag body is inflated and expanded in a driver's seat direction upon input of an impact,
wherein the support frame and the frame fixation part are arranged at a position that does not overlap with the rotation center axis line in a front view of the steering wheel, and
the airbag unit is attached to the frame fixation part.

2. The steering apparatus according to claim 1,
wherein the airbag unit is arranged at a position that does not overlap with the rotation center axis line in the front view of the steering wheel.

3. The steering apparatus according to claim 1,
wherein the airbag unit comprises a break guidance part that starts to break upon inflation and expansion of the bag body, and
at least part of the break guidance part is provided on a surface that faces the rotation center axis line of the airbag unit.

4. The steering apparatus according to claim 1,
wherein the airbag unit has an attachment shaft that extends in a direction substantially perpendicular to a direction directed to a driver's seat and is attached to the frame fixation part by the attachment shaft.

5. The steering apparatus according to claim 1,
wherein the airbag unit is attached to the frame fixation part such that the airbag unit is displaceable substantially in a vertical direction or substantially in a horizontal direction and constitutes a horn operation part.

6. The steering apparatus according to claim 1,
wherein the airbag unit is attached to the frame fixation part via an elastic member such that the airbag unit is displaceable, and
a mass of the airbag unit and the elastic member constitute a dynamic damper.
